(19) United States
(12) Patent Application Publication
(10) Pub. No.: US 2018/0315380 A1
(43) Pub. Date: Nov. 1, 2018

(54) ELECTROWETTING DISPLAY PANEL AND CONTROL METHOD THEREOF

(71) Applicant: BOE TECHNOLOGY GROUP CO., LTD., Beijing (CN)

(72) Inventors: Li XIAO, Beijing (CN); Xiaochuan CHEN, Beijing (CN); Shengji YANG, Beijing (CN); Dongni LIU, Beijing (CN); Lei WANG, Beijing (CN); Jie FU, Beijing (CN); Pengcheng LU, Beijing (CN); Han YUE, Beijing (CN)

(21) Appl. No.: 15/743,551

(22) PCT Filed: Jul. 20, 2017
(86) PCT No.: PCT/CN2017/093599

§ 371 Date: Jan. 10, 2018

(30) Foreign Application Priority Data
Aug. 26, 2016 (CN) 201610729139.9

(51) Int. Cl. G09G 3/34; G09G 3/20; G02B 26/00

(52) U.S. Cl. CPC G09G 3/348; G09G 3/2003; G09G 2300/0426; G09G 2300/0404; G02B 26/005

(57) ABSTRACT

The disclosure relates to an electrowetting display panel and a control method thereof. An electrowetting display panel comprises a plurality of pixel units, each of the pixel units comprising a plurality of sub-pixel units, the sub-pixel unit comprising: at least two liquid layers; and at least one electrode layer, wherein the liquid layers and the electrode layer are stacked alternately; and wherein each of the liquid layers comprises a first insulation layer, a second insulation layer, side walls, and liquid contained in a space surrounded by the first insulation layer, the second insulation layer and the side walls, the liquid comprises colored hydrophobic flowing medium and transparent hydrophilic flowing medium, and the insulation layer of the liquid layer adjacent to the electrode layer is a hydrophobic insulation layer.

### CROSS-REFERENCE TO RELATED APPLICATION

This application claims priority of the Chinese Patent Application No. 201610729139.9 filed on Aug. 26, 2016, the entire disclosure of which is incorporated herein by reference as a part of this application.

### TECHNICAL FIELD

The disclosure relates to an electrowetting display technology, particularly, an electrowetting display panel and a control method thereof.

### BACKGROUND

With the continuous development of display technology, a transparent display screen has become a focus researched by display panel manufacturers. Compared with a traditional liquid crystal display screen, the transparent display screen can bring unprecedented visual perception and a new experience to users. Featured with screen and transparency, the transparent screen may be applied on many scenarios, that is, it can both act as a screen and substitute transparent plate glass. Users may see, through the screen, an object or image located on the opposite surface.

However, due to a high transparency, the transparent display screen has a low contrast during display. Moreover, the color film, as a basis for color display, causes great losses to light transmissivity, and one sub-pixel thereof merely corresponds to one of the three-primary colors (RGB), these badly affect display performances of the transparent display screen.

### SUMMARY OF THE INVENTION

According to an aspect of the disclosure, there is provided an electrowetting display panel comprising: a plurality of pixel units, each of the pixel units comprising a plurality of sub-pixel units, the sub-pixel unit comprising: at least two liquid layers; and at least one electrode layer, wherein the liquid layers and the electrode layer are stacked alternately; and wherein each of the liquid layers comprises a first insulation layer, a second insulation layer, side walls, and liquid contained in a space surrounded by the first insulation layer, the second insulation layer and the side walls, the liquid comprises colored hydrophobic flowing medium and transparent hydrophilic flowing medium, and the insulation layer of the liquid layer adjacent to the electrode layer is a hydrophobic insulation layer.

In the embodiments of the disclosure, the sub-pixel unit comprises at least two electrode layers, and the liquid layer is at the top and/or bottom of the sub-pixel unit.

In the embodiments of the disclosure, the sub-pixel unit comprises a first liquid layer, a first electrode layer, a second liquid layer, a second electrode layer and a third liquid layer which are stacked.

In the embodiments of the disclosure, the colored hydrophobic flowing media of the first liquid layer, the second liquid layer, and the third liquid layer are red, green or blue, respectively, and have different colors.

In the embodiments of the disclosure, the sub-pixel unit comprises at least three electrode layers, and the electrode layers are at the top and bottom of the sub-pixel unit.

In the embodiments of the disclosure, the hydrophobic flowing media of the at least two liquid layers have different colors.

In the embodiments of the disclosure, the colored hydrophobic flowing medium is colored ink.

In the embodiments of the disclosure, the electrode layer comprises a plurality of electrodes spaced from one another.

In the embodiments of the disclosure, the plurality of electrodes are strip-shaped electrodes arranged in parallel with one another.

In the embodiments of the disclosure, the plurality of electrodes are block-shaped electrodes arranged in a matrix.

According to another aspect of the disclosure, there is provided a driving method for the electrowetting display panel comprising: controlling voltages applied on the electrode layers of the sub-pixel units of the electrowetting display panel, to change states of the colored hydrophobic flowing medium and the transparent hydrophilic flowing medium in the liquid layer of the sub-pixel unit.

In the embodiments of the disclosure, the colored hydrophobic flowing medium covers the hydrophobic insulation layer when no voltage is applied on the electrode layer.

In the embodiments of the disclosure, the hydrophilic flowing medium covers the hydrophobic insulation layer when a voltage is applied on the electrode layer.

In the embodiments of the disclosure, the sub-pixel unit comprises a first liquid layer, a first electrode layer, a second liquid layer, a second electrode layer and a third liquid layer which are stacked, each of the first and second electrode layers comprises a first electrode, a second electrode and a third electrode which are strip-shaped and spaced from one another, the first electrode and the third electrode are located at the side walls, respectively, and the second electrode is between the first electrode and the third electrode.

In the embodiments of the disclosure, when no voltage is applied on the first electrode layer and the second electrode layer, the hydrophobic flowing medium of each of the first liquid layer, the second liquid layer and the third liquid layer evenly covers the hydrophobic insulation layer.

In the embodiments of the disclosure, when a voltage is applied on the first electrode of the first electrode layer and the third electrode of the second electrode layer, the hydrophilic flowing media in the first, second and third liquid layers move towards the electrodes on which the voltage is applied, respectively, such that the hydrophobic flowing medium in the first liquid layer is located at the side wall on the third electrode's side, the hydrophobic flowing medium in the third liquid layer is located at the side wall on the first electrode's side, and the hydrophobic flowing medium in the second liquid layer between the first electrode layer and the second electrode layer is located in the middle between the two side walls.

In the embodiments of the disclosure, when a voltage is applied on the first electrode of the second electrode layer, the hydrophobic flowing medium in the first liquid layer evenly covers the hydrophobic insulation layer, and the hydrophilic flow media in the second and third liquid layers move towards the first electrode of the second electrode layer, such that the hydrophobic flow media in the second liquid layer and the third liquid layer are located at the side wall on the third electrode's side.

In the embodiments of the disclosure, when a voltage is applied on the first electrode of the first electrode layer, the hydrophobic flowing medium in the third liquid layer evenly covers the hydrophobic insulation layer, and the hydrophilic flowing media in the first and second liquid layers move towards the first electrode of the first electrode layer, such that the hydrophobic flowing media in the first liquid layer and the second liquid layer are located at the side wall on the third electrode's side.

In the embodiments of the disclosure, when a voltage is applied on the first and second electrodes of the first electrode layer and the second and third electrodes of the second electrode layer, the hydrophilic flowing media in the first, second and third liquid layers move towards the electrodes on which the voltage is applied, respectively, such that the hydrophobic flowing medium in the first liquid layer is located at the side wall on the third electrode's side, the hydrophobic flowing medium in the third liquid layer is located at the side wall on the first electrode's side, and the hydrophobic flowing medium in the second liquid layer between the first electrode layer and the second electrode layer is in a stretched state between the two side walls.

### BRIEF DESCRIPTION OF THE DRAWINGS

In order to illustrate the technical solutions of the embodiments of the disclosure more clearly, a brief introduction to figures in the exemplary embodiments is made as follows. Apparently, the figures described below are merely exemplary and schematic but do not limit the disclosure. An ordinary person skilled in the art may obtain other figures according to these figures. When the disclosure is read with reference to these figures, a person skilled in the art, by referring to a detailed description to the illustrative embodiments below, may better understand respective aspects of the embodiments of the disclosure as well as further objectives and advantages thereof. Among these figures,

FIG. 1 is a structural schematic diagram of the sub-pixel unit of the electrowetting display panel according to the first embodiment in the disclosure;

FIG. 2 is a schematic diagram showing a white display principle of the sub-pixel unit of the electrowetting display panel according to the first embodiment in the disclosure;

FIG. 3 is a schematic diagram showing a red display principle of the sub-pixel unit of the electrowetting display panel according to the first embodiment in the disclosure;

FIG. 4 is a schematic diagram showing a blue display principle of the sub-pixel unit of the electrowetting display panel according to the first embodiment in the disclosure;

FIG. 5 is a schematic diagram showing a green display principle of the sub-pixel unit of the electrowetting display panel according to the first embodiment in the disclosure;

FIG. 6 is a structural schematic diagram of the sub-pixel unit of the electrowetting display panel according to the second embodiment in the disclosure;

FIG. 7 is a schematic diagram showing a white display principle of the sub-pixel unit of the electrowetting display panel according to the second embodiment in the disclosure.

### DETAILED DESCRIPTION OF THE INVENTION

Embodiments of the disclosure will be described in detail hereinafter in conjunction with the accompanying figures in order to make clearer objectives, technical solutions and advantages of the embodiments of the disclosure. Obviously, the embodiments described here are only some rather than all of the embodiments of the disclosure.

Throughout the description, features, advantages or similar expressions involved in the description do not mean that all the features and advantages that are achievable by the disclosure should be or are in any single embodiment of the disclosure. On the contrary, it should be understood that the features, advantages and similar expressions mean that specific features, advantages or characteristics described in conjunction with the embodiments are included in at least one embodiment of the disclosure. In this sense, discussions on features and advantages or similar expressions throughout the description may indicate the same embodiment, but do not necessarily indicate the same embodiment. In addition, the described features, advantages and characteristics of the disclosure may be combined in one or more embodiments in any appropriate manner. A person skilled in the art will be aware that the disclosure may be implemented without one or more specific features or advantages of a specific embodiment. In other examples, additional features and advantages implementable in some embodiments do not necessarily appear in all embodiments of the disclosure.

In the description to the embodiments of the disclosure, it needs to be explained that directional or positional relations indicated by the terms “up”, “down”, “left”, “right”, “top”, “bottom” and so on are based on directional or positional relations shown by the figures. These terms are used to merely facilitate description to the disclosure and simplify the description, but do not indicate or suggest that the indicated devices or elements must have specific directions and positions, or must be structured or operated in specific directions and positions. Thus, these terms should not be considered to limit the disclosure.

In addition, “a plurality of” in the description of the disclosure means two or more, unless it is otherwise explained.

An electrowetting display panel according to the embodiments of the disclosure comprises a plurality of pixel units, each of the pixel units comprising a plurality of sub-pixel units, the sub-pixel unit comprising: at least two liquid layers; and at least one electrode layer, wherein the liquid layers and the electrode layer are stacked alternately; and wherein each of the liquid layers comprises a first insulation layer, a second insulation layer, side walls, and liquid contained in a space surrounded by the first insulation layer, the second insulation layer and the side walls, the liquid comprises colored hydrophobic flowing medium and transparent hydrophilic flowing medium, and the insulation layer of the liquid layer adjacent to the electrode layer is a hydrophobic insulation layer.

In the embodiments of the disclosure, the sub-pixel unit comprises at least two electrode layers, and the liquid layer is at the top and/or bottom of the sub-pixel unit.

In the embodiments of the disclosure, the sub-pixel unit comprises a first liquid layer, a first electrode layer, a second liquid layer, a second electrode layer and a third liquid layer which are stacked.

In the embodiments of the disclosure, the colored hydrophobic flowing media of the first liquid layer, the second liquid layer, and the third liquid layer are red, green or blue, respectively, and have different colors.

In the embodiments of the disclosure, the sub-pixel unit comprises at least three electrode layers, and the electrode layers are at the top and bottom of the sub-pixel unit.

In the embodiments of the disclosure, the hydrophobic flowing media of the at least two liquid layers have different colors.

In the embodiments of the disclosure, the colored hydrophobic flowing medium is colored ink.

In the embodiments of the disclosure, the electrode layer comprises a plurality of electrodes spaced from one another.

In the embodiments of the disclosure, the plurality of electrodes are strip-shaped electrodes arranged in parallel with one another.

In the embodiments of the disclosure, the plurality of electrodes are block-shaped electrodes arranged in a matrix.

Provided is a driving method for the electrowetting display panel according to the embodiments of the disclosure, comprising: controlling voltages applied on the electrode layers of the sub-pixel units of the electrowetting display panel, to change states of the colored hydrophobic flowing medium and the transparent hydrophilic flowing medium in the liquid layer of the sub-pixel unit.

In the embodiments of the disclosure, the colored hydrophobic flowing medium covers the hydrophobic insulation layer when no voltage is applied on the electrode layer.

In the embodiments of the disclosure, the hydrophilic flowing medium covers the hydrophobic insulation layer when a voltage is applied on the electrode layer.

In the embodiments of the disclosure, the sub-pixel unit comprises a first liquid layer, a first electrode layer, a second liquid layer, a second electrode layer and a third liquid layer which are stacked, each of the first and second electrode layers comprises a first electrode, a second electrode and a third electrode which are strip-shaped and spaced from one another, the first electrode and the third electrode are located at the side walls, respectively, and the second electrode is between the first electrode and the third electrode.

In the embodiments of the disclosure, when no voltage is applied on the first electrode layer and the second electrode layer, the hydrophobic flowing medium of each of the first liquid layer, the second liquid layer and the third liquid layer evenly covers the hydrophobic insulation layer.

In the embodiments of the disclosure, when a voltage is applied on the first electrode of the first electrode layer and the third electrode of the second electrode layer, the hydrophilic flowing media in the first, second and third liquid layers move towards the electrodes on which the voltage is applied, respectively, such that the hydrophobic flowing medium in the first liquid layer is located at the side wall on the third electrode's side, the hydrophobic flowing medium in the third liquid layer is located at the side wall on the first electrode's side, and the hydrophobic flowing medium in the second liquid layer between the first electrode layer and the second electrode layer is located in the middle between the two side walls.

In the embodiments of the disclosure, when a voltage is applied on the first electrode of the second electrode layer, the hydrophobic flowing medium in the first liquid layer evenly covers the hydrophobic insulation layer, and the hydrophilic flow media in the second and third liquid layers move towards the first electrode of the second electrode layer, such that the hydrophobic flow media in the second liquid layer and the third liquid layer are located at the side wall on the third electrode's side.

In the embodiments of the disclosure, when a voltage is applied on the first electrode of the first electrode layer, the hydrophobic flowing medium in the third liquid layer evenly covers the hydrophobic insulation layer, and the hydrophilic flowing media in the first and second liquid layers move towards the first electrode of the first electrode layer, such that the hydrophobic flowing media in the first liquid layer and the second liquid layer are located at the side wall on the third electrode's side.

In the embodiments of the disclosure, when a voltage is applied on the first and second electrodes of the first electrode layer and the second and third electrodes of the second electrode layer, the hydrophilic flowing media in the first, second and third liquid layers move towards the electrodes on which the voltage is applied, respectively, such that the hydrophobic flowing medium in the first liquid layer is located at the side wall on the third electrode's side, the hydrophobic flowing medium in the third liquid layer is located at the side wall on the first electrode's side, and the hydrophobic flowing medium in the second liquid layer between the first electrode layer and the second electrode layer is in a stretched state between the two side walls.

In order to make the disclosure more easily understood, following are two embodiments for specific explanations. In the following embodiments, the numbers of liquid layers and electrode layers in each sub-pixel unit are specifically set, and a structure and a color or black-white display principle of the sub-pixel unit are schematically illustrated.

### The First Embodiment

In this embodiment, the sub-pixel unit of the electrowetting display panel comprises a first liquid layer, a first electrode layer, a second liquid layer, a second electrode layer and a third liquid layer which are stacked, wherein each liquid layer includes liquid, a first insulation layer, a second insulation layer and side walls, wherein the liquid is contained in a space surrounded by the first insulation layer, the second insulation layer and the side walls; the liquid includes colored hydrophobic flowing medium (i.e., non-polar flowing medium, such as, colored oily medium, e.g., colored ink and etc.) and transparent hydrophilic flowing medium (i.e., polar flowing medium, such as, water, water solution or alcohol, e.g., electrolyte solution and etc.); the insulation layer adjacent to the electrode layer is a hydrophobic insulation layer.

In this embodiment, the electrowetting display panel may be a transmissive one, a semi-transmissive one or a reflective one, and may use backlight or ambient light as a light source.

The first electrode layer and the second electrode layer may each include a plurality of electrodes (e.g., transparent electrodes) insulated from one another, for example, these electrodes may be a plurality of strip-shaped electrodes arranged in parallel with one another, or a plurality of block-shaped electrodes arranged in a matrix, and so on. A voltage is applied on the plurality of electrodes in the first electrode layer or the second electrode layer, respectively, to control the contact area between the hydrophobic flowing medium and the hydrophobic insulation layer in the liquid layer.

Specifically, for the first liquid layer, when no voltage (i.e., voltage is equal to 0V) is applied on the plurality of electrodes in the first electrode layer, the hydrophobic flowing medium in the first liquid layer may evenly cover the hydrophobic insulation layer, and has the maximum contact area with the hydrophobic insulation layer. Thus, backlight or reflected ambient light is blocked by the colored hydrophobic flowing medium and hence cannot emit out, so as to display the color of the hydrophobic flowing medium.

When a voltage is applied on at least one of the plurality of electrodes in the first electrode layer, the hydrophilic flowing medium moves towards the voltage-applied electrode, such that the hydrophobic flowing medium is located at a side wall on the no-voltage-applied electrode's side, so the contact area between the hydrophobic flowing medium and the hydrophobic insulation layer decreases. Thus, backlight or reflected ambient light may penetrate the transparent hydrophilic flowing medium.

Similarly, for the third liquid layer, when no voltage (i.e., voltage is equal to 0V) is applied on the plurality of electrodes in the second electrode layer, the hydrophobic flowing medium in the third liquid layer may evenly cover the hydrophobic insulation layer, and has the maximum contact area with the hydrophobic insulation layer. Thus, backlight or reflected ambient light is blocked by the colored hydrophobic flowing medium and hence cannot emit out, so as to display the color of the hydrophobic flowing medium.

When a voltage is applied on at least one of the plurality of electrodes in the second electrode layer, the hydrophilic flowing medium moves towards the voltage-applied electrode, such that the hydrophobic flowing medium is located at a side wall on the no-voltage-applied electrode's side, so the contact area between the hydrophobic flowing medium and the hydrophobic insulation layer decreases. Thus, backlight or reflected ambient light may penetrate the transparent hydrophilic flowing medium.

For the second liquid layer between the first electrode layer and the second electrode layer, the first insulation layer and the second insulation layer in the second liquid layer are adjacent to the first electrode layer and the second electrode layer, respectively. When no voltage (i.e., voltage is equal to 0V) is applied on the plurality of electrodes in the first electrode layer and the second electrode layer, the hydrophobic flowing medium in the second liquid layer may evenly cover the hydrophobic insulation layer, and has the maximum contact area with the hydrophobic insulation layer. Thus, backlight or reflected ambient light is blocked by the colored hydrophobic flowing medium and hence cannot emit out, such that the display panel displays the color of the hydrophobic flowing medium.

When a voltage is applied on at least one of the plurality of electrodes in the first electrode layer and/or at least one of the plurality of electrodes in the second electrode layer, the hydrophilic flowing medium moves towards the voltage-applied electrode, such that the final state of the hydrophobic flowing medium (i.e., the form and position of the hydrophobic flowing medium) is determined.

More specifically, taking for instance that the hydrophobic flowing media in the first liquid layer, the second liquid layer, and the third liquid layer in the sub-pixel unit of the electrowetting display panel are red (R), green (G) and blue (B), respectively, FIGS. 1-5 schematically illustrate the structure and the color display principle of the sub-pixel unit. A person skilled in the art may understand that the colors of the hydrophobic flowing media in the first liquid layer, the second liquid layer, and the third liquid layer are not limited to the three-primary colors, and the first liquid layer, the second liquid layer, and the third liquid layer are not limited to be stacked in this order of the colors.

FIG. 1 shows a structural schematic diagram of the sub-pixel unit of the electrowetting display panel according to this embodiment. The sub-pixel structure of the electrowetting display panel comprises a first liquid layer 111, a first electrode layer 121, a second liquid layer 112, a second electrode layer 122 and a third liquid layer 113 which are stacked, wherein each liquid layer includes liquid, a first insulation layer 131, a second insulation layer 132 and side walls 140. The liquid of the first liquid layer 111 includes red ink and transparent hydrophilic flowing medium, the liquid of the second liquid layer 112 includes green ink and transparent hydrophilic flowing medium, and the liquid of the third liquid layer 113 includes blue ink and transparent hydrophilic flowing medium.

As shown by FIG. 1, each of the first electrode layer 121 and the second electrode layer 122 includes three strip-shaped electrodes, but this is merely exemplary and the disclosure is not limited to this.

As shown by FIG. 1, when no voltage is applied on the electrodes in the first electrode layer 121 and the second electrode layer 122, ink (hydrophobic flowing medium) evenly covers the hydrophobic insulation layers. Thus, backlight or reflected ambient light is blocked by the red ink, the green ink and the blue ink and hence cannot emit out, and the sub-pixel appears white owing to overlap of the three-primary colors.

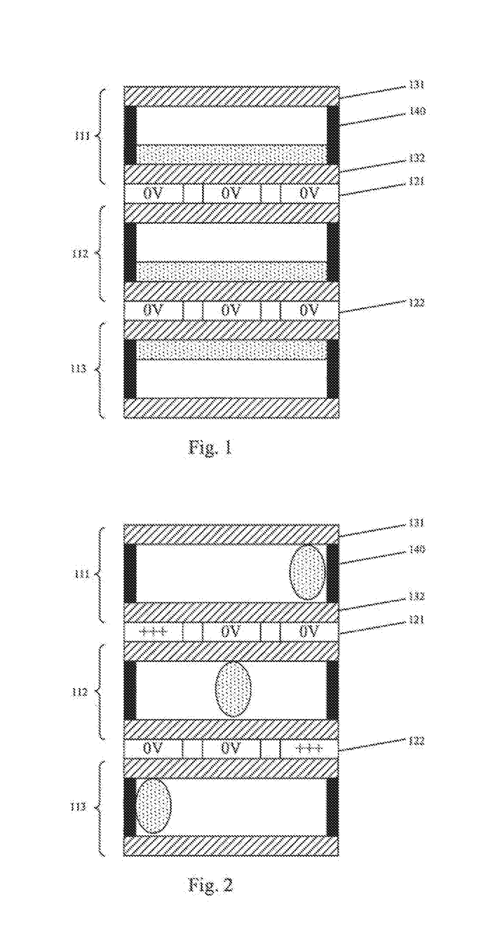

FIGS. 2-5 are schematic diagrams showing a control of color display of the sub-pixel of the electrowetting display panel by applying a voltage to at least one electrode in the first electrode layer 121 and the second electrode layer 122.

As shown by FIG. 2, when a voltage is applied on a left electrode in the first electrode layer 121, but no voltage (i.e., voltage is equal to 0V) is applied on a middle electrode and a right electrode in the first electrode layer 121, the hydrophilic flowing medium in the first liquid layer 111 moves towards the voltage-applied left electrode in the first electrode layer 121, such that the red ink is located at a side wall on the side of the no-voltage-applied right electrode in the first electrode layer 121.

Further, as shown by FIG. 2, a voltage is also applied on a right electrode in the second electrode layer 122, but no voltage is applied on a left electrode and a middle electrode in the second electrode layer 122, at this time, the hydrophilic flowing medium in the third liquid layer 113 moves towards the voltage-applied right electrode in the second electrode layer 122, such that the blue ink is located at a side wall on the side of the no-voltage-applied left electrode in the second electrode layer 122.

As shown by FIG. 2, the hydrophilic flowing medium in the second liquid layer 112 moves towards the voltage-applied left electrode in the first electrode layer 121, meanwhile, the hydrophilic flowing medium in the second liquid layer 112 moves towards the voltage-applied right electrode in the second electrode layer 122, such that the green ink is located at a position corresponding to the middle electrodes in the first electrode layer 121 and in the second electrode layer 122 to reach a balance. Thus, backlight or reflected ambient light may penetrate the transparent hydrophilic flowing medium in respective layers thereby displaying white (the color of backlight or ambient light).

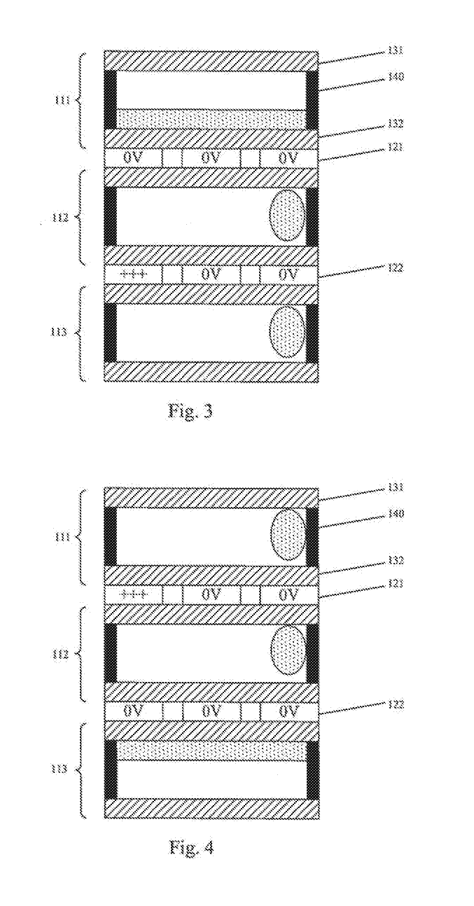

As shown by FIG. 3, no voltage is applied on the electrodes in the first electrode layer 121, thus the red ink (hydrophobic flowing medium) in the first liquid layer 111 evenly covers the hydrophobic insulation layer in the first liquid layer 111.

Further, as shown by FIG. 3, when a voltage is applied on the left electrode in the second electrode layer 122, and no voltage (i.e., voltage is equal to 0V) is applied on the middle electrode and the right electrode in the second electrode layer 122, the hydrophilic flowing medium in the third liquid layer 113 moves towards the voltage-applied left electrode in the second electrode layer 122, such that the blue ink is located at a side wall on the side of the no-voltage-applied right electrode in the second electrode layer 122.

As shown by FIG. 3, when no voltage is applied on the electrodes in the first electrode layer 121, but a voltage is applied on the left electrode in the second electrode layer 122, and no voltage (i.e., voltage is equal to 0V) is applied on the middle electrode and the right electrode in the second electrode layer 122, the hydrophilic flowing medium in the second liquid layer 112 moves towards the voltage-applied left electrode in the second electrode layer 122, such that the green ink is located at a side wall on the side of the no-voltage-applied right electrode in the second electrode layer 122. Thus, backlight or reflected ambient light may penetrate the transparent hydrophilic flowing medium in the second liquid layer 112 and the third liquid layer 113, but is blocked by the red ink in the first liquid layer 111 and cannot emit out, thereby displaying red.

As shown by FIG. 4, when a voltage is applied on the left electrode in the first electrode layer 121, and no voltage (i.e., voltage is equal to 0V) is applied on the middle electrode and the right electrode in the first electrode layer 121, the hydrophilic flowing medium in the first liquid layer 111 moves towards the voltage-applied left electrode in the first electrode layer 121, such that the red ink is located at a side wall on the side of the no-voltage-applied right electrode in the first electrode layer 121.

Further, as shown by FIG. 4, no voltage is applied on the electrodes in the second electrode layer 122, thus the blue ink (hydrophobic flowing medium) in the third liquid layer 113 evenly covers the hydrophobic insulation layer in the third liquid layer 113.

As shown by FIG. 4, when no voltage is applied on the electrodes in the second electrode layer 122, but a voltage is applied on the left electrode in the first electrode layer 121, and no voltage (i.e., voltage is equal to 0V) is applied on the middle electrode and the right electrode in the first electrode layer 121, the hydrophilic flowing medium in the second liquid layer 112 moves towards the voltage-applied left electrode in the first electrode layer 121, such that the green ink is located at a side wall on the side of the no-voltage-applied right electrode in the first electrode layer 121. Thus, backlight or reflected ambient light is blocked by the blue ink in the third liquid layer 113 and cannot emit out, thereby displaying blue.

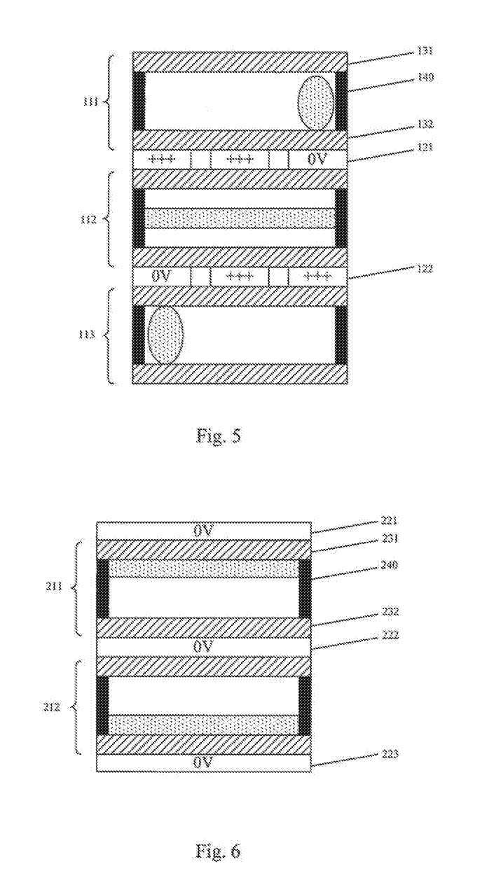

As shown by FIG. 5, when a voltage is applied on the left electrode and the middle electrode in the first electrode layer 121, and no voltage (i.e., voltage is equal to 0V) is applied on the right electrode in the first electrode layer 121, the hydrophilic flowing medium in the first liquid layer 111 moves towards the voltage-applied left and middle electrodes in the first electrode layer 121, such that the red ink is located at a side wall on the side of the no-voltage-applied right electrode in the first electrode layer 121.

Further, as shown by FIG. 5, a voltage is also applied on the middle electrode and the right electrode in the second electrode layer 122, and no voltage is applied on the left electrode in the second electrode layer 122, at this time, the hydrophilic flowing medium in the third liquid layer 113 moves towards the voltage-applied middle and right electrodes in the second electrode layer 122, such that the blue ink is located at a side wall on the side of the no-voltage-applied left electrode in the second electrode layer 122.

The hydrophilic flowing medium in the second liquid layer 112 also moves towards the voltage-applied left and middle electrodes in the first electrode layer 121, meanwhile, the hydrophilic flowing medium in the second liquid layer 112 moves towards the voltage-applied middle and right electrodes in the second electrode layer 122, such that the green ink is in a stretched state between the side of the no-voltage-applied right electrode in the first electrode layer 121 and the side of the no-voltage-applied left electrode in the second electrode layer 122. Thus, backlight or reflected ambient light may penetrate the transparent hydrophilic flowing medium in the third liquid layer 113, but it is blocked by the green ink in the second liquid layer 112, thereby displaying green.

Color display may be realized in one sub-pixel by the foregoing example, thereby improving color gamut.

It is apprehensible for a person skilled in the art that this embodiment may be modified on the basis that the liquid layers and the electrode layers are stacked alternately, by increasing or decreasing the number of liquid layers or electrode layers, setting colors of the hydrophobic flowing media in respective liquid layers, designing electrode patterns (i.e., number, shapes and arrangement manners of the electrodes) of the electrode layers, and controlling voltages applied on the electrode layers to realize color or black-white display of the sub-pixel, which all fall within the protection scope of the disclosure.

### The Second Embodiment

In this embodiment, the sub-pixel unit of the electrowetting display panel comprises a first electrode layer, a first liquid layer, a second electrode layer, a second liquid layer, and a third electrode layer which are stacked, wherein each liquid layer includes liquid, a first insulation layer, a second insulation layer and side walls, wherein the liquid is contained in a space surrounded by the first insulation layer, the second insulation layer and the side walls; the liquid includes colored hydrophobic flowing medium (i.e., non-polar flowing medium, such as, colored oily medium, e.g., colored ink and etc.) and transparent hydrophilic flowing medium (i.e., polar flowing medium, such as, water, water solution or alcohol, e.g., electrolyte solution and etc.); the insulation layers adjacent to the first electrode layer and the third electrode layer, respectively, are hydrophobic insulation layers.

In this embodiment, the electrowetting display panel may be a transmissive one, a semi-transmissive one or a reflective one, and may use backlight or ambient light as a light source.

Each of the first electrode layer and the third electrode layer may be a pixel electrode, and the second electrode layer may be a common electrode. Through control over a voltage applied on each of the pixel electrodes and the common electrode, it is possible to control the contact area between the hydrophobic flowing medium and the hydrophobic insulation layer in the liquid layer.

Specifically, when no voltage (i.e., voltage is equal to 0V) is applied on the pixel electrodes and the common electrode, the hydrophobic flowing medium in the liquid layer may evenly cover the hydrophobic insulation layer, and has the maximum contact area with the hydrophobic insulation layer. Thus, backlight or reflected ambient light is blocked by the colored hydrophobic flowing medium and cannot emit out, thereby displaying the color of the hydrophobic flowing medium.

When a voltage is applied on each of the pixel electrodes, and no voltage (i.e., voltage is equal to 0V) is applied on the common electrode, the hydrophilic flowing medium moves towards the charged pixel electrode, such that the hydrophobic flowing medium is located at a side wall on one side, so the contact area between the hydrophobic flowing medium and the hydrophobic insulation layer decrease.

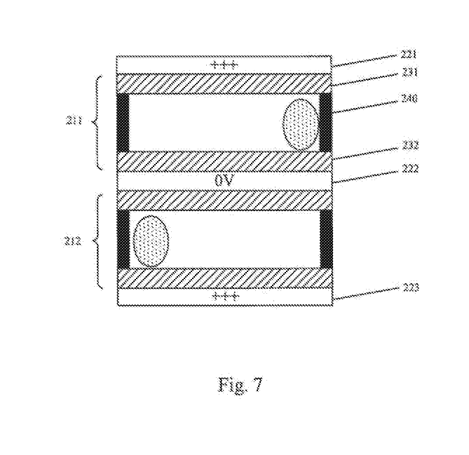

More specifically, taking for instance that the hydrophobic flowing media in the first liquid layer and the second liquid layer in the sub-pixel unit of the electrowetting display panel are black, FIGS. 6-7 schematically illustrate a structure and a black-white display principle of the sub-pixel. A person skilled in the art may understand that the hydrophobic flowing media in the first liquid layer and the second liquid layer are not limited to black.

FIG. 6 shows a structural schematic diagram of the sub-pixel unit of the electrowetting display panel according to this embodiment. The sub-pixel unit of the electrowetting display panel comprises a first electrode layer 221 (a pixel electrode), a first liquid layer 211, a second electrode layer 222 (a common electrode), a second liquid layer 212, and a third electrode layer 223 (a pixel electrode) which are stacked, wherein each liquid layer includes liquid, a first insulation layer 231, a second insulation layer 232 and side walls 240. The liquid of each of the first liquid layer 211 and the second liquid layer 212 includes black ink and transparent hydrophilic flowing medium.

As shown by FIG. 6, when no voltage (i.e., voltage is equal to 0V) is applied on the pixel electrodes and the common electrode, the ink (hydrophobic flowing medium) in each liquid layer evenly covers the hydrophobic insulation layer. Thus, backlight or reflected ambient light is blocked by the black ink and cannot emit out, thereby displaying black.

As shown by FIG. 7, when a voltage is applied on each of the pixel electrodes, and no voltage (i.e., voltage is equal to 0V) is applied on the common electrode, the hydrophilic flowing medium moves towards the voltage-applied pixel electrode, such that the black ink is located at a side wall on one side. Thus, backlight or reflected ambient light may penetrate the transparent hydrophilic flowing medium in the second liquid layer 212 and the first liquid layer 211, thereby displaying white (the color of backlight or ambient light).

Where there is only one pixel electrode layer and one liquid layer, it is assumed that the minimum transmittance is, for example, 0.1 during black display, and the maximum transmittance is, for example, 0.9 during white display, so the contrast ratio is 0.9/0.1=9. By contrast, two such liquid layers are stacked in this embodiment, so the minimum transmittance is, for example, 0.1×0.1=0.01 during black display, and the maximum transmittance is, for example, 0.9×0.9=0.81 during white display, so the contrast ratio in this embodiment is 0.81/0.01=81. Thus, the sub-pixel structure in this embodiment can improve contrast of display.

It is apprehensible for a person skilled in the art that this embodiment may be modified on the basis that the liquid layers and the electrode layers are stacked alternately, by increasing or decreasing the number of liquid layers or electrode layers, setting colors of the hydrophobic flowing media in respective liquid layers, designing electrode patterns (i.e., number, shapes and arrangement manners of the electrodes) of the electrode layers, and controlling voltages applied on the electrode layers to realize color or black-white display of the sub-pixel, which all fall within the protection scope of the disclosure.

In combination with figures, the exemplary embodiments of the disclosure are described above, but these are merely exemplary and schematic illustrations adopted in order to describe and expound a concept of the disclosure, but do not constitute restrictions on respective aspects of the disclosure. A person skilled in the art can understand that, without breaking away from spirit and essence of the disclosure, various modifications and variations may be made to the disclosure, all of which shall fall within the protection scope of the disclosure.

1. An electrowetting display panel comprising:
a plurality of pixel units, each of the pixel units comprising a plurality of sub-pixel units, the sub-pixel unit comprising:
at least two liquid layers; and
at least one electrode layer,
wherein the liquid layers and the electrode layer are stacked alternately; and
wherein each of the liquid layers comprises a first insulation layer, a second insulation layer, side walls, and liquid contained in a space surrounded by the first insulation layer, the second insulation layer and the side walls, the liquid comprises colored hydrophobic flowing medium and transparent hydrophilic flowing medium, and the insulation layer of the liquid layer adjacent to the electrode layer is a hydrophobic insulation layer.

2. The electrowetting display panel according to claim 1, wherein the sub-pixel unit comprises at least two electrode layers, and the liquid layer is at the top and/or bottom of the sub-pixel unit.

3. The electrowetting display panel according to claim 2, wherein the sub-pixel unit comprises a first liquid layer, a first electrode layer, a second liquid layer, a second electrode layer and a third liquid layer which are stacked.

4. The electrowetting display panel according to claim 3, wherein the colored hydrophobic flowing media of the first liquid layer, the second liquid layer, and the third liquid layer are red, green or blue, respectively, and have different colors.

5. The electrowetting display panel according to claim 1, wherein the sub-pixel unit comprises at least three electrode layers, and the electrode layers are at the top and bottom of the sub-pixel unit.

6. The electrowetting display panel according to claim 1, wherein the hydrophobic flowing media of the at least two liquid layers have different colors.

7. The electrowetting display panel according to claim 1, wherein the colored hydrophobic flowing medium is colored ink.

8. The electrowetting display panel according to claim 1, wherein the electrode layer comprises a plurality of electrodes spaced from one another.

9. The electrowetting display panel according to claim 8, wherein the plurality of electrodes are strip-shaped electrodes arranged in parallel with one another.

10. The electrowetting display panel according to claim 8, wherein the plurality of electrodes are block-shaped electrodes arranged in a matrix.

11. A driving method for the electrowetting display panel according to claim 1, comprising:
controlling voltages applied on the electrode layers of the sub-pixel units of the electrowetting display panel, to change states of the colored hydrophobic flowing medium and the transparent hydrophilic flowing medium in the liquid layer of the sub-pixel unit.

12. The driving method according to claim 11, wherein the colored hydrophobic flowing medium covers the hydrophobic insulation layer when no voltage is applied on the electrode layer, and
wherein the hydrophilic flowing medium covers the hydrophobic insulation layer when a voltage is applied on the electrode layer.

13. (canceled)

14. The driving method according to claim 12, wherein the sub-pixel unit comprises a first liquid layer, a first electrode layer, a second liquid layer, a second electrode layer and a third liquid layer which are stacked, each of the first and second electrode layers comprises a first electrode, a second electrode and a third electrode which are strip-shaped and spaced from one another, the first electrode and the third electrode are located at the side walls, respectively, and the second electrode is between the first electrode and the third electrode.

15. The driving method according to claim 14, wherein when no voltage is applied on the first electrode layer and the second electrode layer, the hydrophobic flowing medium of each of the first liquid layer, the second liquid layer and the third liquid layer evenly covers the hydrophobic insulation layer.

16. The driving method according to claim 14, wherein when a voltage is applied on the first electrode of the first electrode layer and the third electrode of the second electrode layer, the hydrophilic flowing media in the first, second and third liquid layers move towards the electrodes on which the voltage is applied, respectively, such that the hydrophobic flowing medium in the first liquid layer is located at the side wall on the third electrode's side, the hydrophobic flowing medium in the third liquid layer is located at the side wall on the first electrode's side, and the hydrophobic flowing medium in the second liquid layer between the first electrode layer and the second electrode layer is located in the middle between the two side walls.

17. The driving method according to claim 14, wherein when a voltage is applied on the first electrode of the second electrode layer, the hydrophobic flowing medium in the first liquid layer evenly covers the hydrophobic insulation layer, and the hydrophilic flow media in the second and third liquid layers move towards the first electrode of the second electrode layer, such that the hydrophobic flow media in the second liquid layer and the third liquid layer are located at the side wall on the third electrode's side.

18. The driving method according to claim 14, wherein when a voltage is applied on the first electrode of the first electrode layer, the hydrophobic flowing medium in the third liquid layer evenly covers the hydrophobic insulation layer, and the hydrophilic flowing media in the first and second liquid layers move towards the first electrode of the first electrode layer, such that the hydrophobic flowing media in the first liquid layer and the second liquid layer are located at the side wall on the third electrode's side.

19. The driving method according to claim 14, wherein when a voltage is applied on the first and second electrodes of the first electrode layer and the second and third electrodes of the second electrode layer, the hydrophilic flowing media in the first, second and third liquid layers move towards the electrodes on which the voltage is applied, respectively, such that the hydrophobic flowing medium in the first liquid layer is located at the side wall on the third electrode's side, the hydrophobic flowing medium in the third liquid layer is located at the side wall on the first electrode's side, and the hydrophobic flowing medium in the second liquid layer between the first electrode layer and the second electrode layer is in a stretched state between the two side walls.

20. The driving method according to claim 11, wherein the sub-pixel unit comprises at least two electrode layers, and the liquid layer is at the top and/or bottom of the sub-pixel unit.

21. The driving method according to claim 11, wherein the sub-pixel unit comprises at least three electrode layers, and the electrode layers are at the top and bottom of the sub-pixel unit.
